(19) United States
(12) Patent Application Publication
(10) Pub. No.: US 2007/0219045 A1
(43) Pub. Date: Sep. 20, 2007

(54) Control device for a hybrid electric vehicle

(76) Inventors: Makoto Ogata, Kanagawa (JP); Tatsuo Kiuchi, Kanagawa (JP)

Correspondence Address: JACOBSON HOLMAN PLLC, 400 SEVENTH STREET N.W., SUITE 600, WASHINGTON, DC, 20004, US

(21) Appl. No.: 11/723,295

(22) Filed: Mar. 19, 2007

(30) Foreign Application Priority Data
Mar. 17, 2006 (JP) 2006-74671

(51) Int. Cl. B60K 1/02

(52) U.S. Cl. 477/3

(57) ABSTRACT

A hybrid electric vehicle is equipped with an engine output system that makes the engine generate a driving force and outputs the driving force of the engine and a motor output system that makes an electric motor generate a driving force and outputs the driving force of the electric motor, and is capable of transmitting to driving wheels the driving forces outputted from the respective systems. If a failure of the motor output system is not detected, a vehicle ECU sets the gear of an automatic transmission for start-up of the vehicle to a first gear. If the failure is detected, the vehicle ECU sets the gear of the automatic transmission for start-up the vehicle to a second gear that is lower than the first gear.

### BACKGROUND OF THE INVENTION

1. Field of the Invention

The present invention relates to a control device for a hybrid electric vehicle, and more specifically to a control device for a hybrid electric vehicle capable of transmitting a driving force of an engine and that of an electric motor to driving wheels of a vehicle.

2. Description of the Related Art

A hybrid electric vehicle equipped with an engine output system that makes an engine generate a driving force and outputs the driving force and a motor output system that makes an electric motor generate a driving force and outputs the driving force has conventionally been well known. As a hybrid electric vehicle of this type, a parallel hybrid electric vehicle capable of transmitting the driving forces outputted from both the systems to the driving wheels of the vehicle has been developed and in practical use.

Such a parallel hybrid electric vehicle is proposed, for example, in Unexamined Japanese Patent Publication No. 5-176405 (hereinafter, referred to as Patent Document 1), in which there is provided a clutch that mechanically connects/disconnects an engine and an automatic transmission to each other, and a rotary shaft of an electric motor is coupled to between the output shaft of the clutch and the input shaft of the automatic transmission.

In the hybrid electric vehicle described in Patent Document 1, the clutch is disengaged at the start-up of the vehicle, and the vehicle starts traveling simply by using the driving force of the electric motor operated as a motor by electric power supply from a battery. During the running of the vehicle after the start-up, the clutch is engaged, so that the driving forces of the engine and the electric motor can be transmitted to the driving wheels through the transmission.

When the vehicle can be driven by using the driving force of the engine and that of the electric motor at the same time as described above, the torque required for driving the vehicle is properly divided between the engine and the electric motor. The driving force of the engine and that of the electric motor in motor operation, which are outputted according to the divided torques, are transmitted to the driving wheels through the transmission, and this drives the vehicle. According to the running state of the vehicle at this moment, the gear shift of the automatic transmission and engagement/disengagement of the clutch are properly controlled.

Although the location of the electric motor is not the same as in the hybrid electric vehicle of Patent Document 1, Unexamined Japanese Patent Publication No. 2003-269597 (hereinafter, referred to as Document 2) proposes a hybrid electric vehicle capable of transmitting the driving forces of the engine and the electric motor to driving wheels, in which a gear of a transmission for start-up the vehicle is changed according to the output generable from the electric motor.

In the hybrid electric vehicle described in Patent Document 2, when the output generable from the electric motor is large, the vehicle is started in a higher gear than that when the output is small. Consequently, the fuel consumption of the engine is improved, and the drive feeling at acceleration after the start-up is enhanced.

In the hybrid electric vehicle capable of transmitting the driving forces of the engine and the electric motor to the driving wheels of the vehicle, if there is a failure in the electric motor, inverter or battery making up the motor output system, it is conceivable that the power supply from the battery to the electric motor is cut off, and that the vehicle is driven only by the driving force of the engine which is outputted from the engine output system.

In this case, however, the driving force of the electric motor which is outputted from the motor output system cannot be used. This raises the problem that the vehicle cannot be properly started and accelerated due to the insufficiency of the driving force transmitted to the driving wheels.

### SUMMARY OF THE INVENTION

An aspect of the present invention is directed to a control device for a hybrid electric vehicle equipped with an engine output system that makes an engine generate a driving force and outputs the driving force of the engine and a motor output system that makes an electric motor generate a driving force and outputs the driving force of the electric motor, the vehicle being capable of transmitting the driving forces outputted from the respective systems to driving wheels, the control device comprising: an automatic transmission that has a plurality of forward gears and transmits to the driving wheels the driving force of the engine which is outputted from the engine output system; a failure detection means for detecting a failure of the motor output system; and a control means that sets a gear of the automatic transmission for start-up of the vehicle to a first gear when the failure is not detected by the failure detection means, and on the other hand, sets the gear of the automatic transmission for start-up of the vehicle to a second gear that is lower than the first gear when the failure is detected by the failure detection means.

### BRIEF DESCRIPTION OF THE DRAWINGS

The present invention will become more fully understood from the detailed description given hereinafter and the accompanying drawings which are given by way of illustration only, and thus, are not limitative of the present invention, and wherein:

FIG. 1 is a configuration view of a substantial part of a hybrid electric vehicle having a control device according to one embodiment of the present invention;

FIG. 2 is a flowchart showing a gear shift map switching control performed in the hybrid electric vehicle of FIG. 1;

FIG. 3 is a diagram showing a gear shift map SU1 for upshift;

FIG. 4 is a diagram showing a gear shift map SU2 for upshift;

FIG. 5 is a diagram showing a gear shift map SD1 for downshift;

FIG. 6 is a diagram showing a gear shift map SD2 for downshift;

FIG. 7 is a flowchart showing a switching control of a clutch control performed in the hybrid electric vehicle of FIG. 1; and

FIG. 8 is a diagram showing a relationship between a upper limit decelerating of an electric motor torque and a required decelerating torque.

### DETAILED DESCRIPTION OF THE INVENTION

An embodiment of the present invention will now be described with reference to the attached drawings.

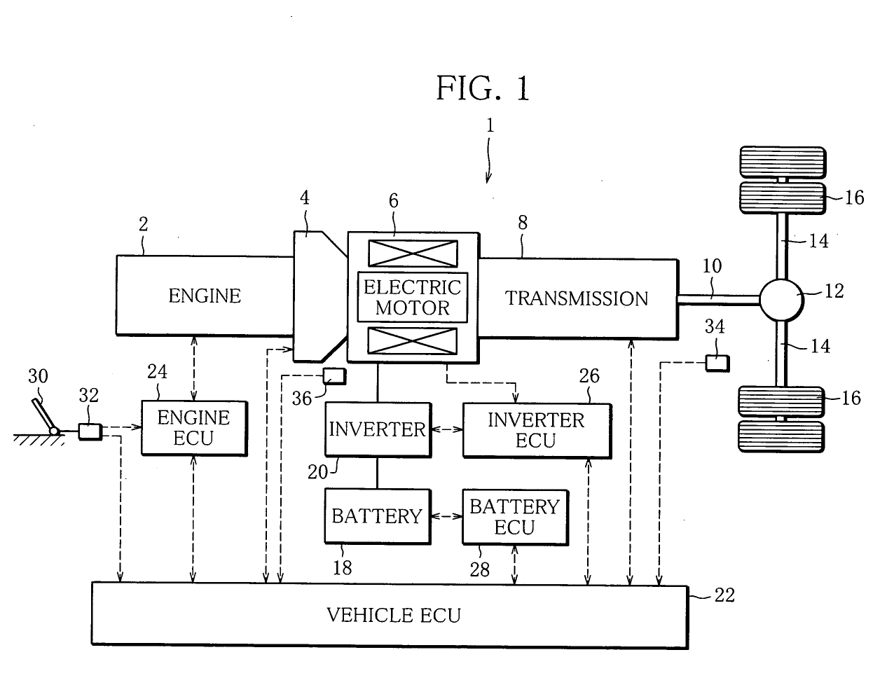

FIG. 1 is a diagram showing a substantial part of a hybrid electric vehicle 1 to which the present invention is applied.

An input shaft of a clutch 4 is coupled to an output shaft of an engine 2, which is a diesel engine. An output shaft of the clutch 4 is coupled to an input shaft of an automatic transmission (hereinafter referred to as transmission) 8 having five forward gears (hereinafter referred to simply as gears) through a rotary shaft of a permanent-magnetic synchronous motor (hereinafter referred to as electric motor) 6. An output shaft of the transmission 8 is connected to left and right driving wheels 16 through a propeller shaft 10, a differential gear unit 12 and driving shafts 14.

Therefore, when the clutch 4 is engaged, both the output shaft of the engine 2 and the rotary shaft of the electric motor 6 can be mechanically connected with the driving wheels 16. On the other hand, when the clutch 4 is disengaged, only the rotary shaft of the electric motor 6 can be mechanically connected with the driving wheels 16.

The electric motor 6 is operated as a motor when DC power stored in a battery 18 is supplied to the electric motor 6 after being converted into AC power by an inverter 20. A driving torque of the electric motor 6 is transmitted to the driving wheels 16 after being shifted to a proper speed by the transmission 8. At the time of deceleration of the vehicle, the electric motor 6 is operated as a generator. Kinetic energy created by the revolution of the driving wheels 16 is transmitted to the electric motor 6 through the transmission 8 to be converted into AC power, thereby producing a decelerating torque caused by regenerative braking force. This AC power is then converted into DC power by the inverter 20 and is then charged to the battery 18. In this manner, the kinetic energy created by the revolution of the driving wheels 16 is retrieved as electrical energy.

Meanwhile, a driving torque of the engine 2 is transmitted to the transmission 8 through the rotary shaft of the electric motor 6 when the clutch 4 is engaged. After being shifted to a proper speed, the driving torque of the engine 2 is transmitted to the driving wheels 16. Therefore, in a case where the electric motor 6 is operated as a motor while the driving torque of the engine 2 is transmitted to the driving wheels 16, both the driving torque of the engine 2 and the driving torque of the electric motor 6 are transmitted to the driving wheels 16. In other words, a part of the driving torque to be transmitted to the driving wheels 16 to drive the vehicle is supplied from the engine 2, and at the same time, the remainder of the driving torque is supplied from the electric motor 6.

If a storage rate (hereinafter referred to as SOC) of the battery 18 lowers and the battery 18 then needs to be charged, the electric motor 6 is operated as a generator. Moreover, the electric motor 6 is driven by using a part of the driving torque of the engine 2, to thereby carry out power generation. The AC power thus generated is converted into DC power by the inverter 20, and the battery 18 is charged with this DC power.

A vehicle ECU (control means) 22 performs engagement/disengagement control of the clutch 4 and gear shift control of the transmission 8 according to an operating state of the vehicle, an operating state of the engine 2, and information from an engine ECU 24, an inverter ECU 26, a battery ECU (storage rate detection means) 28, etc. In addition, the vehicle ECU 22 performs an integrated control for appropriately controlling the engine 2 and the electric motor 6 in accordance with states of the above-mentioned controls, and the various kinds of states, such as start-up, acceleration and deceleration of the vehicle.

The hybrid electric vehicle 1 is provided with an accelerator opening sensor 32 that detects the depression amount of an accelerator pedal 30, a vehicle speed sensor 34 that detects the traveling speed of the vehicle, and a revolution speed sensor (revolution speed detection means) 36 that detects the revolution speed of the electric motor 6. When performing the controls described above, the vehicle ECU 22 calculates a total driving torque and a total decelerating torque based on the detection results supplied from the accelerator opening sensor 32, the vehicle speed sensor 34 and the revolution speed sensor 36. Furthermore, the vehicle ECU 22 sets a torque to be generated by the engine 2 and a torque to be generated by the electric motor 6, based on the total driving torque and the total decelerating torque.

The engine ECU 24 performs various kinds of controls necessary for the operation of the engine 2 per se, including start/stop control and idling control of the engine 2, regeneration control of an exhaust emission purification device (not shown), and the like. In addition, the engine ECU 24 controls fuel injection quantity, fuel injection timing, etc. of the engine 2 so that the engine 2 generates the torque required in the engine 2, which has been set by the vehicle ECU 22.

The inverter ECU 26 controls the inverter 20 based on the torque to be generated by the electric motor 6, which has been set by the vehicle ECU 22, and thereby controls the electric motor 6 to be operated as a motor or a generator. The inverter ECU 26 receives output signals from temperature sensors (not shown) that detect the temperatures of the electric motor 6 and the inverter 20, and outputs the detection results of the temperatures of the electric motor 6 and the inverter 20 to the vehicle ECU 22. Furthermore, the inverter ECU 26 monitors operating states of the electric motor 6 and the inverter 20, and sends information of the monitoring results to the vehicle ECU 22.

The battery ECU 28 detects the temperature of the battery 18, the voltage of the battery 18, and the current flowing between the inverter 20 and the battery 18, etc. In addition, the battery ECU 28 obtains the SOC of the battery 18 from these detection results, and monitors the operating state of the battery 18. The battery ECU 28 sends the obtained SOC and operating state of the battery 18 to the vehicle ECU 22 together with the detection results.

The hybrid electric vehicle 1 is configured as described above, in which the engine 2 and the engine ECU 24 constitute an engine output system, while the electric motor 6, the battery 18, the inverter 20, the inverter ECU 26 and the battery ECU 28 constitute a motor output system.

With the hybrid electric vehicle 1 thus configured, an outline of controls performed mainly by the vehicle ECU 22, in the hybrid electric vehicle 1 configured as described above, to make the vehicle travel is as follows:

First, it is assumed that the vehicle is at rest with the engine 2 stopped. When a driver performs a start-up operation of the engine 2 using a starter switch (not shown) with a shift change lever (not shown) in a neutral position, the vehicle ECU 22 confirms that the transmission 8 is in a neutral position so that the electric motor 6 and the driving wheels 16 are mechanically disconnected, and that the clutch 4 is engaged. Then the vehicle ECU 22 indicates to the inverter ECU 26 a driving torque of the electric motor 6 required for starting the engine 2, and commands the engine ECU 24 to operate the engine 2.

The inverter ECU 26 operates the electric motor 6 as a motor to generate a driving torque based on the indication from the vehicle ECU 22, thereby cranking the engine 2. At this point, the engine ECU 24 starts fuel supply to the engine 2, thereby causing the engine 2 to starts. After the start-up of the engine 2, the engine 2 enters idling operation.

After the engine 2 is started in this manner, the engine 2 is in an idle operational state when the vehicle is at rest. When the driver operates the change lever to a drive position or the like, the vehicle ECU 22 disengages the clutch 4 and at the same time sets the gear of the transmission 8 to a gear for start-up of the vehicle according to a gear shift map. Furthermore, when the driver steps on the accelerator pedal 30, the vehicle ECU 22 obtains a driving torque to be transmitted to the driving wheels 16 to start traveling of the vehicle, in accordance with a depression amount of the accelerator pedal 30 detected by the accelerator opening sensor 32. The vehicle ECU 22 sets an output torque of the electric motor 6 based on the obtained driving torque and the gear currently used in the transmission 8.

The inverter ECU 26 controls the inverter 20 according to the torque set by the vehicle ECU 22, so that DC power of the battery 18 is converted into AC power by the inverter 20 and supplied to the electric motor 6. Supplied with AC power, the electric motor 6 is operated as a motor to generate the driving torque. The driving torque of the electric motor 6 is transmitted to the driving wheels 16 through the transmission 8, and the vehicle thereby starts traveling.

When the vehicle accelerates after the start of traveling, and the revolution speed of the electric motor 6 rises to the vicinity of the idling speed of the engine 2, it is possible to engage the clutch 4 to transmit the driving force of the engine 2 to the driving wheels 16. The vehicle ECU 22 obtains a driving torque to be transmitted to the driving wheels 16 for further acceleration and subsequent traveling of the vehicle. The vehicle ECU 22 then appropriately divide the driving torque into an output torque of the engine 2 and an output torque of the electric motor 6 according to the gear currently used in the transmission 8 and the operating state of the vehicle, and indicates to the engine ECU 24 and the inverter ECU 26 the divided output torques respectively. At this point, the vehicle ECU 22 controls the transmission 8 and the clutch 4 as necessary.

Upon receipt of the output torques set by the vehicle ECU 22, the engine ECU 24 and the inverter ECU 26 respectively control the engine 2 and the electric motor 6. As a result, when the clutch 4 is engaged, the output torques of the engine 2 and the electric motor 6 are transmitted to the driving wheels 16 through the transmission 8, and thereby the vehicle travels. On the other hand, when the clutch 4 is disengaged, the output torque generated by the electric motor 6 is transmitted to the driving wheels 16 through the transmission 8, and thereby the vehicle travels.

Additionally, at this point, the vehicle ECU 22 suitably performs a gear shift control of the transmission 8 in accordance with operating states of the vehicle such as the depression amount of the accelerator pedal 30 detected by the accelerator opening sensor 32 and the traveling speed detected by the vehicle speed sensor 34. Furthermore, in accordance with the switching of speed ranges, the vehicle ECU 22 instructs the engine ECU 24 and the inverter ECU 26 to appropriately control torques of the engine 2 and the electric motor 6 in response to the gear shift of the transmission 8, and at the same time, controls engagement/disengagement of the clutch 4.

An upper limit torque, which is maximum torque continuously generable by the electric motor 6, is determined depending on the specifications of the electric motor 6. When causing the electric motor 6 to generate torque, the vehicle ECU 22 controls the electric motor 6 so that the output torque of the electric motor 6 does not exceed the upper limit torque.

However, in cases in which the SOC of the battery 18 lowers extremely for some reasons, or the temperature of the battery 18 or the electric motor 6 lowers significantly in cold climates, an output torque equivalent to the upper limit torque may not be obtained from the electric motor 6. Additionally, in a case where the temperatures of the battery 18, the electric motor 6 or the inverter 20 rises excessively, output of the electric motor 6 is limited to a limited torque that is lower than the upper limit torque in order to protect the battery 18, the electric motor 6 or the inverter 20.

To ensure that required driving force is transmitted to the driving wheels 16 even in these cases, the vehicle ECU 22 switches the gear shift maps that are used in performing a gear shift control of the transmission 8 according to operating states of the vehicle.

In addition, the vehicle ECU 22 monitors whether the motor output system has a failure based on information sent from the inverter ECU 26 and the battery ECU 28. Failures of the motor output system include a failure of an inverter circuit (not shown) used in the inverter 20, defective cells in the battery 18 and the like. If the motor output system has such a failure, the vehicle ECU 22 instructs the inverter ECU 26 to cut off the electrical connection between the battery 18 and the inverter 20. In response to this instruction, the inverter ECU 26 controls the inverter 20 to cut off the electrical connection between the battery 18 and the inverter 20.

Since the electrical connection between the battery 18 and the inverter 20 is cut off in this manner, the electric motor 6 is operated neither as a motor nor as a generator. Therefore, when the clutch 4 is engaged, the electric motor 6 is driven by the driving force to rotate together with the engine 2.

As the electric motor 6 ceases to be operated, it is unable to transmit a driving force from the motor output system to the driving wheels 16. In order to arrange so that a required driving force can be transmitted to the driving wheels 16 even in these cases, depending on whether or not the motor output system has a failure, the vehicle ECU 22 switches the gear shift maps that are used in performing a gear shift control of the transmission 8 according to operating states of the vehicle.

As described above, the vehicle ECU 22 switches the gear shift maps depending on whether or not the motor output system has a failure in addition to whether or not an output torque equivalent to the upper limit torque can be obtained from the electric motor 6.

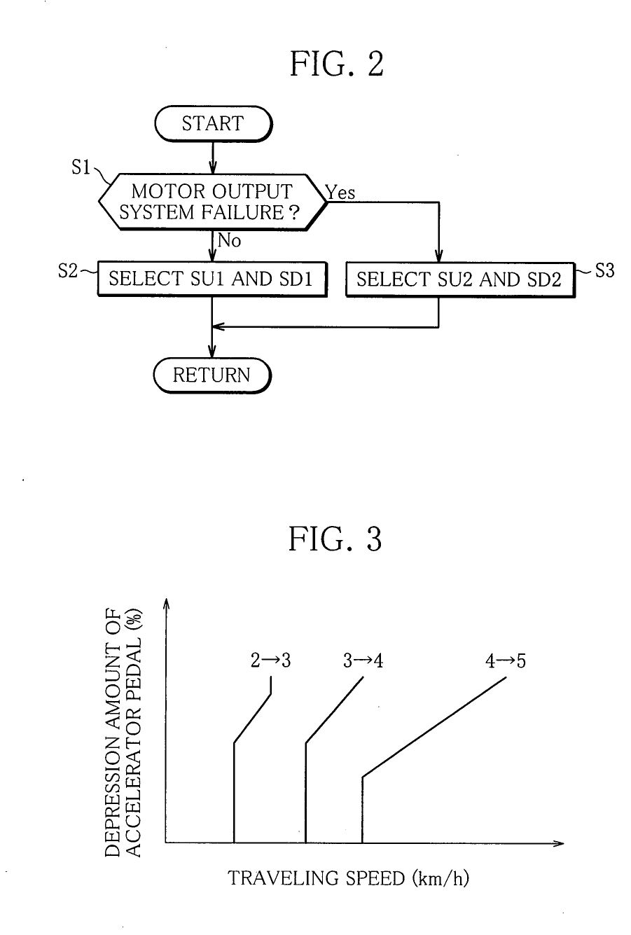

Such gear shift map switching control is performed by the vehicle ECU 22 at predetermined control periods according to a flowchart shown in FIG. 2.

Upon commencement of the gear shift map switching control, in Step S1 (failure detection means), the vehicle ECU 22 judges, based on the information from the inverter ECU 26 and the battery 28, whether or not the motor output system has a failure.

If the vehicle ECU 22 judges in Step S1 that the motor output system has no failure or, in other words, that the motor output system is normal, the vehicle ECU 22 advances the process to Step S2. In Step S2, the vehicle ECU 22 selects a gear shift map SU1 for upshift and a gear shift map SD1 for downshift, and then concludes the present control period.

On the other hand, if the vehicle ECU 22 judges in Step S1 that the motor output system has a failure, the vehicle ECU 22 advances the process to Step S3. In Step S3, the vehicle ECU 22 selects a gear shift map SU2 for upshift and a gear shift map SD2 for downshift, and then concludes the present control period.

In the next control period, the vehicle ECU 22 again performs the gear shift map switching control from Step S1, and selects gear shift maps in either Step S2 or Step S3, as described above.

By repeating the gear shift map switching control for each control period in this manner, the vehicle ECU 22 appropriately selects a gear shift map for upshift and a gear shift map for downshift, depending on whether or not the motor output system has a failure. More specifically, if the vehicle ECU 22 judges that the motor output system is normal, the gear shift map SU1 for upshift and the gear shift map SD1 for downshift are selected. On the other hand, if the vehicle ECU 22 judges that the motor output system has a failure, the gear shift map SU2 for upshift and the gear shift map SD2 for downshift are selected.

All of these gear shift maps are used when of the transmission 8 is upshifted/downshifted according to the depression amount of the accelerator pedal 30 detected by the accelerator opening sensor 32 and the traveling speed detected by the vehicle speed sensor 34.

Among these gear shift maps, the gear shift map SU1 for upshift is shown in FIG. 3. As shown in FIG. 3, for the gear shift map SU1, an upshift line (2→3) from a second gear to a third gear, an upshift line (3→4) from the third gear to a fourth gear, and an upshift line (4→5) from the fourth gear to a fifth speed are set in accordance with the depression amount of the accelerator pedal 30 and the traveling speed of the vehicle.

Therefore, when a change in the operating state of the vehicle causes a point determined by the depression amount of the accelerator pedal 30 and the traveling speed to move across the upshift line (2→3) from the second gear to the third gear from left to right on the diagram, the vehicle ECU 22 upshifts the transmission 8 from the second gear to the third gear. The procedures for the upshift line (3→4) from the third gear to the fourth gear and the upshift line (4→5) from the fourth gear to the fifth gear are similar to that of the upshift line (2→3) from the second gear to the third gear. In other words, when a point determined by the depression amount of the accelerator pedal 30 and the traveling speed moves across each upshift line from left to right of the diagram, a corresponding upshift is performed.

Since the output torque of the electric motor 6 is used in combination with the output torque of the engine 2, the gear shift map SU1 for upshift is set so that the transmission 8 is upshifted earlier in comparison with a gear shift map of an automatic transmission that is applied to a vehicle not equipped with an electric motor and uses an engine as a sole driving source. As a result, when both the engine 2 and the electric motor 6 are used for driving the vehicle, it is possible to improve fuel efficiency of the engine 2 with ensuring the driving force necessary for driving the vehicle.

In addition, when the motor output system is normal, the lowest forward gear is the second gear as shown in FIG. 3, and upon start-up of the vehicle, the vehicle ECU 22 sets the gear of the transmission 8 to the second gear and causes the vehicle to start traveling. Therefore, in the present embodiment, the second gear corresponds to the first gear of the present invention.

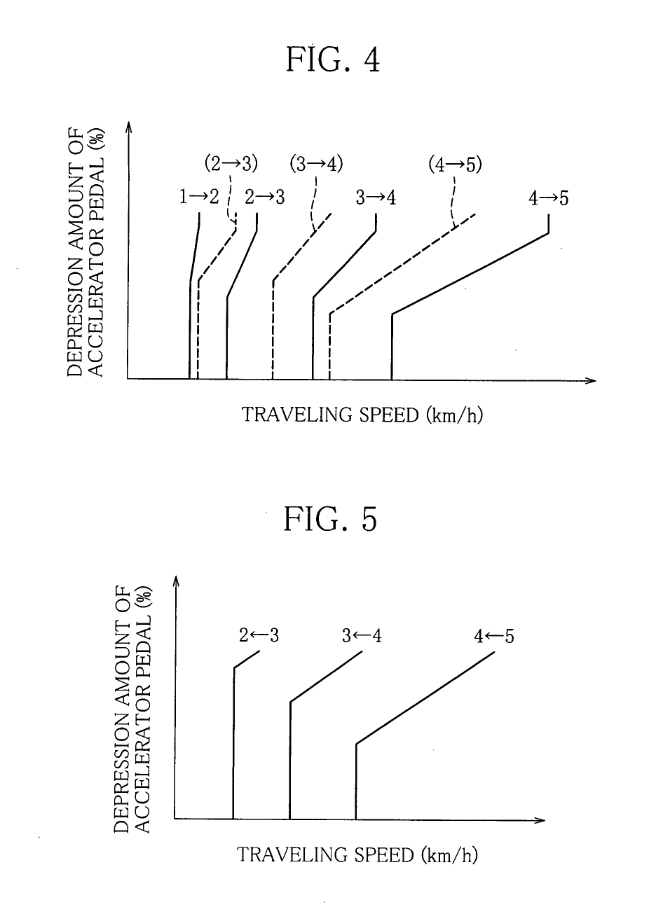

On the other hand, FIG. 4 shows the gear shift map SU2 for upshift. For the gear shift map SU2, as indicated by the solid lines in FIG. 4, an upshift line (1→2) from a first gear to the second gear, an upshift line (2→3) from the second gear to the third gear, an upshift line (3→4) from the third gear to the fourth gear, and an upshift line (4→5) from the fourth gear to the fifth gear are set in accordance with the depression amount of the accelerator pedal 30 and the traveling speed of the vehicle.

When this gear shift map is used, the transmission 8 is upshifted in the same manner as the case where the gear shift map SU1 for upshift is used. However, as shown in FIG. 4, the upshift line (1→2) from the first gear to the second gear, which is not included in the gear shift map SU1 for upshift, is set for the gear shift map SU2 for upshift. More specifically, when the motor output system has a failure, the lowest gear is the first gear, and upon start-up of the vehicle, the vehicle ECU 22 sets the gear of the transmission 8 to the first gear to start traveling of the vehicle. Therefore, in the present embodiment, the first gear corresponds to the second gear of the present invention.

In addition, FIG. 4 shows the respective upshift lines of the gear shift map SU1 for upshift as indicated by the dotted lines. As shown in FIG. 4, in comparison to the upshift lines of the gear shift map SU1, the corresponding upshift lines of the gear shift map SU2 for upshift are all set so that the transmission 8 is upshifted at a high-speed side for the same depression amount of the accelerator pedal 30. Moreover, with respect to the same traveling speed, the transmission 8 is upshifted at the stage where the depression amount of the accelerator pedal 30 is smaller. Therefore, in an operating state where the driver presses the accelerator pedal, and the traveling speed is then increased, the transmission 8 is upshifted after the traveling speed is sufficiently increased. In an operating state where the driver determines that the traveling speed has been sufficiently increased and then reduces the depression amount of the accelerator pedal, the transmission 8 is upshifted after the depression amount of the accelerator pedal is sufficiently reduced. In other words, when using the gear shift map SU2 for upshift, in accordance with changes in the operating state of the vehicle, the transmission 8 is upshifted later than the case where the gear shift map SU1 for upshift is used.

FIG. 5 shows a gear shift map SD1 for downshift, which is selected when the motor output system is normal. As shown in FIG. 5, for the gear shift map SD1, a downshift line (4←5) from the fifth gear to the fourth gear, a downshift line (3←4) from the fourth gear to the third gear, and a downshift line (2←3) from the third gear to the second gear are set in accordance with the depression amount of the accelerator pedal 30 and the traveling speed of the vehicle.

Therefore, when a change in the operating state of the vehicle causes a point determined by the depression amount of the accelerator pedal 30 and the traveling speed to move across the downshift line (4←5) from the fifth gear to the fourth gear from right to left on the diagram, the vehicle ECU 22 downshifts the transmission from the fifth gear to the fourth gear. In addition, the procedures for the downshift line (3←4) from the fourth gear to the third gear and the downshift line (2←3) from the third gear to the second gear are similar to that of the downshift line (4←5) from the fifth gear to the fourth gear. More specifically, when a point determined by the depression amount of the accelerator pedal 30 and the traveling speed of the vehicle moves across each downshift line from right to left of the diagram, a corresponding downshift is performed.

When the motor output system is normal, the downshift of the transmission 8 is only performed down to the second gear, as shown in FIG. 5. Therefore, as described earlier, at the next start-up of the vehicle, the vehicle ECU 22 sets the gear of the transmission 8 to the second gear to start traveling of the vehicle.

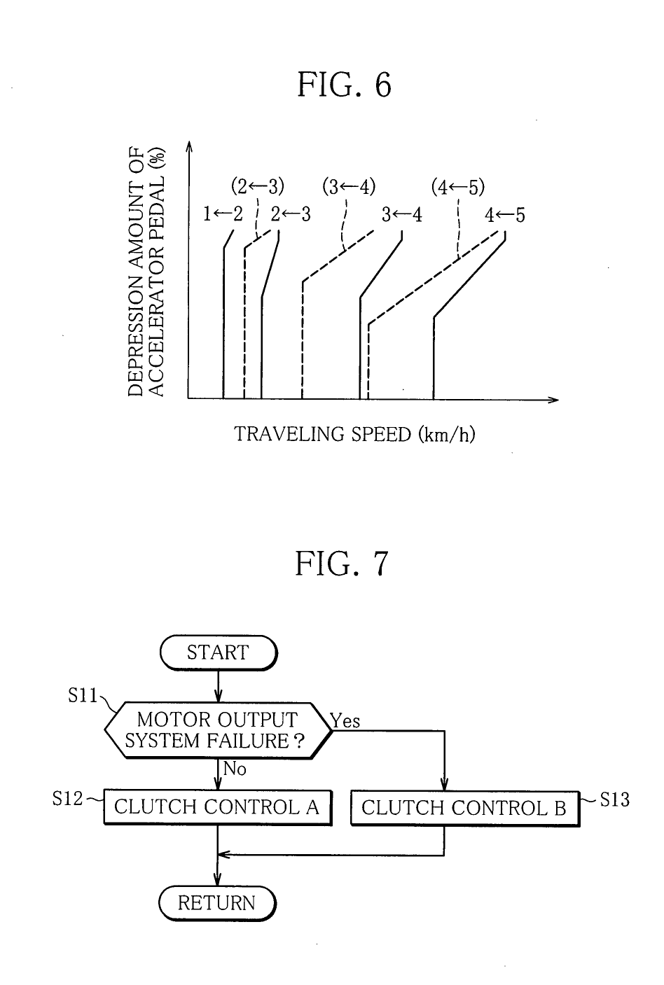

In comparison, FIG. 6 shows a gear shift map SD2 for downshift, which is used when the motor output system has a failure. For the gear shift map SD2, a downshift line (4←5) from the fifth gear to the fourth gear, a downshift (3←4) line from the fourth gear to the third gear, a downshift line (2←3) from the third gear to the second gear and a downshift line (1←2) from the second gear to the first gear are set as indicated by the solid lines in FIG. 6, in accordance with the depression amount of the accelerator pedal 30 and the traveling speed of the vehicle.

When this gear shift map is used, the transmission 8 is downshifted in the same manner as the case where the gear shift map SD1 for downshift is used. However, as shown in FIG. 6, a downshift line (1←2) from the second gear to the first gear, which is not included in the gear shift map SD1 for downshift, is set for the gear shift map SD2 for downshift. Therefore, when the motor output system has a failure, the downshift of the transmission 8 is performed down to the first gear. As described earlier, at the next start-up of the vehicle, the vehicle ECU 22 sets the gear of the transmission 8 to the first gear to start traveling of the vehicle.

In addition, FIG. 6 shows the respective downshift lines of the gear shift map SD1 for downshift as indicated by the dotted lines. In comparison to the downshift lines of the gear shift map SD1, the corresponding downshift lines of the gear shift map SD2 for downshift are all set so that the transmission 8 is downshifted at a high-speed side for the same depression amount of the accelerator pedal 30. As to the downshift that is performed by pressing the accelerator pedal (so-called kickdown), too, the transmission 8 is downshifted in a smaller depression amount of the accelerator pedal with respect to the same traveling speed. In other words, when using the gear shift map SD2 for downshift, in accordance with changes in the operating state of the vehicle, the transmission 8 is downshifted earlier than the case where the gear shift map SD1 for downshift is used.

By selecting and using the respective gear shift maps set as described above, driving force is transmitted to the driving wheels 16 as described below.

In the event that the gear shift map SU1 for upshift and the gear shift map SD1 for downshift are selected by the gear shift map switching control because the motor output system is normal, when the driver performs start-up operations of the vehicle as described above, the vehicle ECU 22 disengages the clutch 4 and sets the gear of the transmission 8 to the second gear according to the selected gear shift maps. The vehicle ECU 22 then sets an output torque to be generated by the electric motor 6 when the gear is set to the second gear based on a driving torque to be transmitted to the driving wheel 16, which is set according to the depression amount of the accelerator pedal 30. In accordance with the set driving torque of the electric motor 6, the inverter ECU 26 controls the inverter 20 and thereby the driving force of the electric motor 6 is transmitted to the driving wheels 16 through the transmission 8. As a result, the vehicle starts traveling.

In this manner, when the motor output system is normal, the vehicle ECU 22 sets the gear of the transmission 8 to the second gear and cause the vehicle to start traveling by means of the electric motor 6. This enables smooth start-up of the vehicle.

When the vehicle accelerates after the start-up, and the revolution speed of the electric motor 6 rises to the vicinity of the idling speed of the engine 2, it is possible to engage the clutch 4 to transmit the driving force of the engine 2 to the driving wheels 16. The vehicle ECU 22 determines a driving torque to be transmitted to the driving wheels 16 for further acceleration and subsequent traveling of the vehicle. Based upon the determined driving torque, the vehicle ECU 22 then obtains a required torque to be outputted from the engine 2 and the motor 2 according to the gear currently used in the transmission 8, and appropriately divides the required torque between an engine 2 side and a electric motor 6 side based on the operating state of the vehicle.

When the vehicle ECU 22 divides the required torque between the engine 2 and the electric motor 6, the vehicle ECU 22 first determines the output torque of the engine 2 according to the revolution speed of the engine 2, and if the determined output torque of the engine 2 is below the required torque, the vehicle ECU 22 sets the deficiency thereof as the output of the electric motor 6. At this point, in consideration of the exhaust emission characteristic of the engine 2, in a relatively low engine revolution speed range, the output torque of the engine 2 is limited within a torque range where the output torque is equal to or lower than a predetermined allowable torque and where NOx emission of the engine 2 is low. Therefore, the vehicle ECU 22 controls the engine 2 and the electric motor 6 so that the required torque is solely obtained from the engine 2 until the required torque exceeds the allowable torque. If the required torque exceeds the allowable torque, the vehicle ECU 22 controls the engine 2 and the electric motor 6 so that the engine 2 outputs the allowable torque and, at the same time, the deficiency is outputted from the electric motor 6.

In addition, during traveling of the vehicle as described above, the vehicle ECU 22 upshifts/downshifts the transmission 8 in accordance with the depression amount of the accelerator pedal 30 detected by the accelerator opening sensor 32 and the traveling speed detected by the vehicle speed sensor 34, based on the selected gear shift map SU1 for upshift and the gear shift map SD1 for downshift. At this point, the vehicle ECU 22 controls the clutch 4 as necessary.

More specifically, as described above, when a point determined by the depression amount of the accelerator pedal 30 and the traveling speed of the vehicle moves across an upshift line of the gear shift map SU1 for upshift shown in FIG. 3, the transmission 8 is upshifted. When the point moves across a downshift line of the gear shift map SD1 for downshift shown in FIG. 5, the transmission 8 is downshifted.

Therefore, in the event that the vehicle starts up and accelerates, the transmission 8 is sequentially upshifted in accordance with the increase in traveling speed. At this point, since the gear for start-up of the vehicle is set to the second gear as described above, the number of upshifts required to reach the fifth gear is less than that in the case where the gear for start-up is set to the first gear, thereby enabling smooth acceleration.

On the other hand, in the event that the gear shift map SU2 for upshift and the gear shift map SD2 for downshift are selected by the gear shift map switching control because the motor output system has a failure, when the driver performs start-up operations of the vehicle as described above, the vehicle ECU 22 disengages the clutch 4, and sets the gear of the transmission 8 to the first gear according to the selected gear shift maps.

In this case, since the electric motor 6 is not operated, the vehicle ECU 22 instructs the engine ECU 24 to output a torque corresponding to the depression amount of the accelerator pedal 30 from the engine 2, and at the same time, controls the clutch 4 to be engaged partially. Upon receiving the instruction from the vehicle ECU 22, the engine ECU 24 controls the engine 2 so that the engine 2 outputs a torque in accordance with the depression amount of the accelerator pedal 30 detected by the accelerator opening sensor 32 and the revolution speed of the engine 2. The driving torque of the engine 2 is transmitted to the driving wheels 16 through the clutch 4 in a partially engaged state and the transmission 8, and thereby the vehicle starts traveling.

Although driving force will not be transmitted from the electric motor 6 to the driving wheels 16, since the gear used in the transmission 8 at this point is the first gear, driving force necessary for start-up of the vehicle can be transmitted to the driving wheels 16. As a result, it is possible to prevent deterioration of driving performance and driving feeling due to insufficient driving force upon vehicle start-up.

When the vehicle accelerates after the start-up and the revolution speed of the electric motor 6 rises to the vicinity of the idling speed of the engine 2, the vehicle ECU 22 completely engages the clutch 4, and determines a driving torque to be transmitted to the driving wheels 16 for further acceleration and subsequent traveling of the vehicle. Subsequently, based on this driving torque, the vehicle ECU 22 obtains a required torque to be outputted from the engine 2 in accordance with the gear currently used in the transmission 8, and instructs the engine ECU 24 to have the engine 2 output this required torque.

In addition, the vehicle ECU 22 upshifts/downshifts the transmission 8 in accordance with the changes in the depression amount of the accelerator pedal 30 detected by the accelerator opening sensor 32 and the traveling speed detected by the vehicle speed sensor 34, based on the selected gear shift map SU2 for upshift and the gear shift map SD2 for downshift. At this point, the vehicle ECU 22 controls the clutch 4 as necessary.

More specifically, as described above, when a point determined by the depression amount of the accelerator pedal 30 and the traveling speed of the vehicle moves across an upshift line of the gear shift map SU2 for upshift shown in FIG. 4, the transmission 8 is upshifted. When the point moves across a downshift line of the gear shift map SD2 for downshift shown in FIG. 6, the transmission 8 is downshifted.

At this time, in comparison to the gear shift map SU1 for upshift and the gear shift map SD1 for downshift, the gear shift map SU2 for upshift and the gear shift map SD2 for downshift are set so that the transmission 8 is upshifted later and the transmission 8 is downshifted earlier in response to the changes in the depression amount of the accelerator pedal 30 and the traveling speed of the vehicle. Therefore, it is possible to secure driving force necessary for acceleration even if driving force can not be obtained from the electric motor 6 and the driving wheels 16 is driven solely by the driving force of the engine 2. As a result, it is possible to suppress deterioration of driving performance and driving feeling due to insufficient driving force.

In addition to the gear shift map switching control described above, the vehicle ECU 22 also switches the control of the clutch 4, which is performed when the depression of the accelerator pedal 30 is released and the vehicle decelerates, depending on whether or not the motor output system has a failure.

More specifically, during deceleration of the hybrid electric vehicle 1, it is possible to appropriately decelerate the vehicle using the regenerative braking force of the electric motor 6 as described above. If the motor output system has a failure, however, it is unable to use such a regenerative braking force. For this reason, by switching the control of the clutch 4, the vehicle ECU 22 ensures that the vehicle is appropriately decelerated even if the motor output system has a failure.

Such switching control of the clutch control by the vehicle ECU 22 is performed at predetermined control periods according to a flowchart shown in FIG. 7.

Upon commencement of switching control of the clutch control, the vehicle ECU 22 judges in Step S11 (failure detection means) whether or not the motor output system has a failure based on the information from the inverter ECU 26 and the battery ECU 28 in the same manner as the procedure of Step S1 in the switching control of the gear shift maps shown in FIG. 2.

If the vehicle ECU 22 judges in Step S11 that the motor output system has no failure or, in other words, that the motor output system is normal, the vehicle ECU 22 selects a clutch control A in Step S12, and then concludes the present control period. On the other hand, if the vehicle ECU 22 judges in Step S11 that the motor output system has a failure, the vehicle ECU 22 selects a clutch control B in Step S13, and then concludes the present control period.

By repeating the judgment of Step S11 in this manner for each control period, the vehicle ECU 22 selects either the clutch control A or the clutch control B depending on whether or not the motor output system has a failure.

During deceleration of the vehicle, in combination with the clutch control thus selected, the vehicle ECU 22 controls the engine 2 and the electric motor 6 as described below.

In the event that the depression of the accelerator pedal 30 is released when the motor output system is normal, the vehicle ECU 22 sets a decelerating torque necessary for appropriately decelerating the vehicle as a required decelerating torque based on the revolution speed of the electric motor 6 detected by a revolution speed sensor 36 and the gear currently used in the transmission 8.

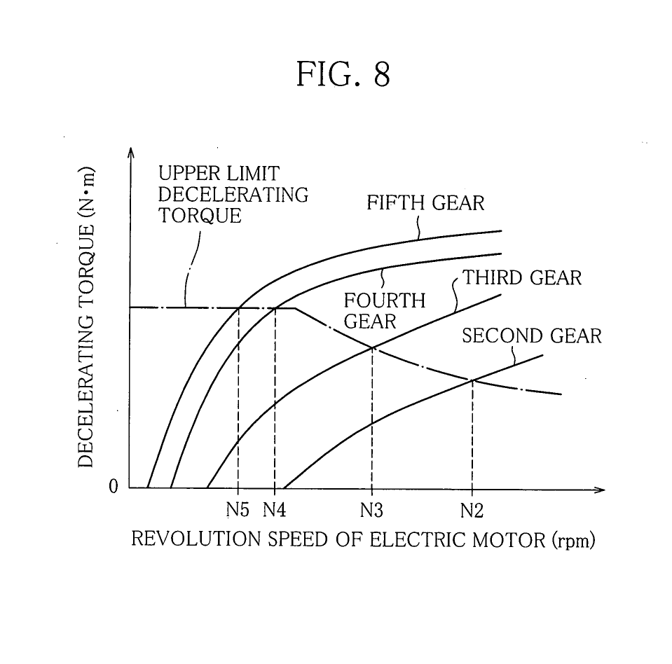

The required decelerating torque is individually set for each gear of the transmission 8, as indicated by the solid lines in FIG. 8. Required decelerating torques corresponding to the respective gears increase as the revolution speed of the electric motor 6 increases. In addition, as shown in FIG. 8, the required decelerating torques are set so that the higher the gear, the greater the required decelerating torque.

Furthermore, the vehicle ECU 22 sets an upper limit value of a regenerative braking torque that can be generated by the electric motor 6 at the revolution speed of the electric motor 6 detected by the revolution speed sensor 36 as an upper limit decelerating torque. This upper limit decelerating torque is determined based on the specifications of the electric motor 6 according to the revolution speed of the electric motor 6. As indicated by the chain line in FIG. 8, the upper limit decelerating torque has a characteristic that the upper limit decelerating torque has a constant value in a low revolution speed range and decreases as the revolution speed of the electric motor 6 increases in a high revolution speed range. Moreover, as shown in FIG. 8, the magnitude correlations between the upper limit decelerating torque and each required decelerating torque corresponding to the respective gears are reversed at each revolution speed from N2 to N5.

If the required decelerating torque is greater than the upper limit decelerating torque having the above characteristics, the regenerative braking torque of the electric motor 6 alone is insufficient in obtaining the required decelerating torque. Therefore, the vehicle ECU 22 engages the clutch 4, and controls the engine 2 and the electric motor 6 so that the required decelerating torque is obtained by combining the decelerating torque of the engine 2 and the decelerating torque of the electric motor 6 attributable to regenerative braking.

On the other hand, if the required decelerating torque is equal to or lower than the upper limit decelerating torque, the required decelerating torque can be solely obtained from the regenerative braking torque of the electric motor 6. Therefore, the vehicle ECU 22 disengages the clutch 4, and controls the electric motor 6 so that the required decelerating torque is solely obtained by the regenerative braking of the electric motor 6.

By performing the control in this manner, the vehicle ECU 22 uses the regenerative braking of the electric motor 6 to recover energy as much as possible during deceleration. Thus, in the clutch control A that is selected when the motor output system is normal, the vehicle ECU 22 controls the engagement/disengagement state of the clutch 4 according to the magnitude correlation between the required decelerating torque and the upper limit decelerating torque.

On the other hand, in a case where it is detected that the motor output system has a failure, regenerative braking force can not be obtained from the electric motor 6. Therefore, when depression of the accelerator pedal 30 is released, the vehicle ECU 22 engages the clutch 4. In addition, the vehicle ECU 22 instructs the engine ECU 24 to perform deceleration operations of the engine 2 such as stopping the fuel supply to the engine 2, and in the case where an exhaust brake has been provided, operating the exhaust brake.

Following the instructions from the vehicle ECU 22, the engine ECU 24 performs deceleration operations of the engine 2 by stopping the fuel supply to the engine 2, and when the exhaust brake has been provided, by operating the exhaust brake.

As a result, the decelerating torque of the engine 2 is transmitted from the transmission 8 to the driving wheels 16 through the clutch 4 so that the vehicle is decelerated. At this point, since the clutch 4 is engaged, the revolution speed detected by the revolution speed sensor 36 is equal to the rotation of the engine 2. When the traveling speed decreases along with the deceleration of the vehicle and the vehicle ECU 22 detects that the revolution speed of the engine 2 has dropped to the vicinity of the idling speed based on the revolution speed detected by the revolution speed sensor 36, the vehicle ECU 22 disengages the clutch 4 in order to prevent the revolution speed of the engine 2 from dropping below the idling speed.

As described above, in the clutch control B that is selected when a failure is detected in the motor output system, the vehicle ECU 22 maintains engagement of the clutch 4 until the revolution speed of the engine 2 has dropped to the vicinity of the idling speed, and the vehicle is decelerated by the decelerating torque of the engine 2.

Consequently, even in the event that the motor output system has a failure and the regenerative braking force of the electric motor 6 can not be used, it is possible to continuously transmit the decelerating torque necessary for the appropriate deceleration of the vehicle to the driving wheel 16, in combination with the use of the gear shift map SD2 for downshift in which the transmission 8 is downshifted earlier as described above. As a result, the vehicle will be able to decelerate in a preferable manner.

In the above, the control device for a hybrid electric vehicle according to an embodiment of the present invention have been described. However, it should be noted that the present invention is not limited to the embodiment described above.

For instance, in the above embodiment, the gear of the transmission 8 for start-up of the vehicle is set to the first gear in the case where the motor output system has a failure, and on the other hand, the gear for start-up of the vehicle is set to the second gear in the case where the motor output system is normal. However, the gear for start-up of the vehicle in the each case is not limited to the above. The gear for start-up of the vehicle may be set depending on the specifications of the vehicle. In this case, the gear for start-up of the vehicle in the case where the motor output system has a failure is set to a lower gear as compared with the gear for start-up of the vehicle in the case where the motor output system is normal.

In the above embodiment, the gear of the transmission 8 for start-up of the vehicle is changed between a situation in which the motor output system has a failure and a situation in which the motor output system is normal by switching the gear shift maps. Alternatively, a common gear shift map may be used in both the situations, and if it is detected that the motor output system has a failure, only the gear for start-up of the vehicle may be changed to the first gear.

In a vehicle equipped with a manual shift range with which the driver can change the gear of the transmission 8 by operating the change lever for upshift or downshift, gear shift maps are not used while this manual range is selected. In such a vehicle, when the manual range is selected, the same effect can be achieved by changing only the gear for start-up of the vehicle.

In the above embodiment, the electric motor 6 is disposed between the clutch 4 and the transmission 8, but the location of the electric motor 6 is not limited to the above. A similar effect can be obtained with any hybrid electric vehicle in which the driving force of the engine 2 and the driving force of the electric motor 6 can be transmitted to the driving wheels 16 respectively, such as a hybrid electric vehicle in which the electric motor 6 is disposed between the engine 2 and the clutch 4.

In the above embodiment, the transmission 8 is configured as an automatic transmission having five forward gears. However, the number of the gears and the type of the automatic transmission is not limited to the above. For instance, a continuously variable transmission may be used instead.

In the above embodiment, the revolution speed of the electric motor 6 detected by the revolution speed sensor 36 is used. However, an output revolution speed of the transmission 8 may alternatively be detected and converted into the revolution speed of the electric motor 6 using a gear ratio currently used in the transmission 8. Otherwise, the revolution speed of the electric motor 6 may be obtained from a quantity that changes according to the revolution speed of the electric motor 6.

In the above embodiment, the engine 2 is configured as a diesel engine, but the type of the engine is not limited to the above, and a gasoline engine or the like may be used instead.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A control device for a hybrid electric vehicle equipped with an engine output system that makes an engine generate a driving force and outputs the driving force of the engine and a motor output system that makes an electric motor generate a driving force and outputs the driving force of the electric motor, the vehicle being capable of transmitting the driving forces outputted from the respective systems to driving wheels, the control device comprising:
an automatic transmission that has a plurality of forward gears and transmits to the driving wheels the driving force of the engine which is outputted from the engine output system;
a failure detection means for detecting a failure of the motor output system; and
a control means that sets a gear of the automatic transmission for start-up of the vehicle to a first gear when the failure is not detected by the failure detection means, and on the other hand, sets the gear of the automatic transmission for start-up of the vehicle to a second gear that is lower than the first gear when the failure is detected by the failure detection means.

2. The control device for a hybrid electric vehicle according to claim 1, wherein:
the control means changes the gear of the automatic transmission for start-up of the vehicle between a situation in which the failure is detected by the failure detection means and a situation in which the failure is not detected by the failure detection means by switching gear shift maps for controlling the automatic transmission according to a change in an operating state of the vehicle.

3. The control device for a hybrid electric vehicle according to claim 2, wherein:
the gear shift map that is selected when a failure of the motor output system is detected by the failure detection means is configured so that the transmission is downshifted earlier according to a change in the operating state of the vehicle, and upshifted later according to a change in the operating state of the vehicle, as compared to the gear shift map that is selected when a failure of the motor output system is not detected by the failure detection means.
